(19) United States
(12) Patent Application Publication
(10) Pub. No.: US 2014/0120372 A1
(43) Pub. Date: May 1, 2014

(54) Plating Process to Increase Coin Blank Surface Hardness

(71) Applicants: Hieu Cong Truong, Ottawa (CA); Toan Dinh Nguyen, Ottawa (CA); Dennis Herman Weber, Johnson City, TN (US)

(72) Inventors: Hieu Cong Truong, Ottawa (CA); Toan Dinh Nguyen, Ottawa (CA); Dennis Herman Weber, Johnson City, TN (US)

(73) Assignee: MONNAIE ROYALE CANADIENNE/ROYAL CANADIAN MINT, Ottawa, ON (CA)

(21) Appl. No.: 14/126,362

(22) PCT Filed: Jun. 12, 2012
(86) PCT No.: PCT/CA2012/050394

§ 371 Date: Dec. 13, 2013

Related U.S. Application Data
(60) Provisional application No. 61/498,088, filed on Jun. 17, 2011.

(51) Int. Cl. B32B 15/01; C22F 1/08; C21D 9/00

(52) U.S. Cl. CPC B32B 15/015; C21D 9/0068; C22F 1/08
USPC 428/679; 148/529; 148/536

(57) ABSTRACT

A method is for plating metal or alloy blanks. The method includes heating the metal or alloy blanks at a recrystallization temperature sufficient to soften the steel for minting; plating the softened metal or alloy blanks with one or more layers of metal or alloy; and heating the plated blanks at a temperature sufficient to reduce plating stresses but below the recrystallization temperature of the outermost plating layer.

### FIELD

The present disclosure relates generally to a process for plating a coin blank.

### BACKGROUND

At the beginning of the twentieth century, circulation coins were made of silver alloys. In order to reduce costs, in the nineteen fifties circulation coins were made of non ferrous base alloys; and in the nineteen seventies, plated steel materials were used. In order to make plated steel circulation coins, one or more layers of metal are plated directly on the steel.

A mono-ply plating process is used to plate a single layer on the steel, for example, copper (plated using a cyanide process) or nickel (plated using an acidic process with nickel sulphate or nickel sulfamate). In the mono-ply plating process, the coin blanks are annealed after plating at about 850° C. in order to make the steel blank soft enough for minting.

A multi-ply plating process is used to plate more than two layers on the steel and is discussed in U.S. Pat. Nos. 5,319,886 and 5,151,167. In a multi-ply plating process, the steel may be plated with, for example, nickel, copper and then more nickel. In the multi-ply plating process, the blanks are annealed after plating at about 800° C. in order to make the steel blank soft enough for minting. The multi-ply plating process overcomes various shortcomings of the mono-ply plating process, for example the use of toxic copper cyanides and the abrasive nature of the columnar microstructure of the plated nickel which is excessively detrimental to coining die life.

A bi-ply plating process is used to plate two layers on the steel. For example, the steel is first plated with copper (using a cyanide process), then nickel is plated (using a acidic process with nickel sulphate or nickel sulfamate) over the copper to give the blank a white silvery color. In the bi-ply plating process, the blanks are annealed after plating at about 800° C. in order to make the steel blank soft enough for minting. The bi-ply plating is an economic compromise of the multi-ply plating since the first layer of nickel may be substituted by a thicker layer of copper. The bi-ply plating is more environmentally unfriendly and potentially dangerous than the multi-ply plating process since both cyanide and acid are used in close proximity to each other and could accidentally react to release deadly gases.

In all the three plating processes, the average total plating deposit thickness is normally specified to be 25 microns. This specified thickness is chosen in order to protect the steel against steel corrosion and is a function of the metal surface hardness and the desired resistance to wear and tear over the desired 20 year circulation life of the coin.

Annealing the plated blanks produced in any of the mono-, bi-, or multi-ply processes at a temperature of 800° C. or higher, as needed to soften the steel for minting, also softens the nickel and/or copper plating layer(s) and reduces the wear resistance of the nickel and/or copper plating layer(s). The annealed blanks can have a superficial micro-hardness of about 159 on the Vickers scale with a force of 10 g and a dwell time of 15 seconds; and a bulk hardness of about 33 to 53 on the R30T scale.

It is desirable to provide a plating process that results in a plated coin with increased wear resistance while maintaining a softened steel core suitable for minting. It is desirable for the plated coin with increased wear resistance to have a reduced total plating deposit thickness so as to reduce material costs.

Additionally, steel is often produced with a surface layer of an organic compound, for example an organic rolling oil or rust prohibition compound, in order to minimize friction and to cool down the steel during rolling. The organic compound is also used to reduce rusting during storage and transit. In order to ensure good adhesion of the plating metal to the steel blank, this organic compound is removed using solvents, for example alkaline washing compounds and acidic decapant materials, which then need to be disposed of in an environmentally appropriate manner.

It is desirable to provide a plating process that removes organic material from the steel without the use of solvents.

### SUMMARY

It is an object of the present disclosure to obviate or mitigate at least one disadvantage of previous processes for plating coin blanks.

In an aspect, the present disclosure provides a method for plating metal or alloy blanks that includes heating the metal or alloy blanks at a recrystallization temperature sufficient for the metal or alloy to undergo a recrystallization to soften the metal or alloy for minting; plating the softened metal or alloy blanks with one or more layers of metal or alloy; and heating the plated blanks at a temperature sufficient to reduce plating stresses but below the recrystallization temperature of the outermost plating layer.

The metal or alloy blanks may be steel, copper, brass, aluminum/bronze, 60Cu/40Zn alloy, 70Cu/30Zn alloy, 80Cu/20Zn alloy, Cu/Zn/Sn alloy, white bronze, or cupro-nickel blanks. The steel blanks may be heated at a recrystallization temperature between about 725° C. and about 950° C., or about 800° C. and about 850° C. The copper blanks may be heated at a recrystallization temperature between about 625° C. and about 675° C. The brass blanks may be heated at a recrystallization temperature between about 650° C. and about 700° C. The aluminum/bronze blanks may be heated at a recrystallization temperature between about 700 and about 750° C.

The blanks may be heated for about 2 hours. The blanks may be heated from room temperature and may be cooled down to room temperature.

After plating, the plated blanks may then be heated at a temperature to remove plating stresses but below the recrystallization temperature of the outermost plating layer, for example between about 425° C. and 550° C. for nickel plating, or about 225° C. and 275° C. for copper plating. The temperature will vary according to the plating to be annealed. The plated blanks may be heated for about 20 minutes to 30 minutes at the temperature to remove plating stresses. The time required for heating the plated blanks to the temperature to remove plating stresses and cooling to room temperature depends on the furnace design and may take, for example, a total of 1.5 to 3 hours.

The metal or alloy blanks may be heated at the recrystallization temperature in a reducing atmosphere. The plated blanks may be heated to a temperature to remove plating stresses in a neutral atmosphere or in a reducing atmosphere. The reducing atmosphere may include cracked ammonia, or a mixture of nitrogen and hydrogen ranging from greater than 0% to 100% hydrogen.

In another aspect, the present disclosure provides a plated steel blank that includes a steel core having a bulk hardness of between about 27 and 53 on the R30T scale; and at least one plating layer, of which one of the at least one plating layer is an outer plating layer, the outer plating layer having a micro hardness of about 245 to about 280 on the Vickers Scale measured with a force of 10 g and a dwell time of 15 seconds.

The total thickness of the plating layer or layers may be from about 12 to 25 microns.

Other aspects and features of the present disclosure will become apparent to those ordinarily skilled in the art upon review of the following description of specific embodiments in conjunction with the accompanying figures.

### BRIEF DESCRIPTION OF THE DRAWINGS

Embodiments of the present disclosure will now be described, by way of example only, with reference to the attached Figures.

FIG. 1A is a photograph at 50× magnification of a ready-to-strike, 15 micron, mono-ply Nickel plated steel blank, which was heated at a temperature of 850° C. after plating;

FIG. 1B is a photograph at 50× magnification of a ready-to-strike, 25 micron, mono-ply Nickel plated steel blank, which was heated at a temperature of 850° C. after plating;

FIG. 1C is a photograph at 50× magnification of a ready-to-strike, 25 micron, mono-ply Nickel plated steel coin, which was heated at a recrystallization temperature of 780° C. before being Nickel plated and then heated at a temperature of 450° C. to remove plating stresses;

FIG. 2A is a photograph at 50× magnification of a 15 micron, mono-ply Nickel plated steel coin, which was heated at a recrystallization temperature of 850° C. after plating, after 4 hours of wear testing;

FIG. 2B is a photograph at 50× magnification of a 25 micron, mono-ply Nickel plated steel coin, which was heated at a temperature of 850° C. after plating, after 4 hours of wear testing;

FIG. 2C is a photograph at 50× magnification of a 25 micron, mono-ply Nickel plated steel coin, which was heated at a recrystallization temperature of 780° C. before being Nickel plated and then heated at a temperature of 450° C. to remove plating stresses, after 4 hours of wear testing;

FIG. 3A is a photograph at 100× magnification of the plated steel coin shown in FIG. 2A;

FIG. 3B is a photograph at 100× magnification of the plated steel coin shown in FIG. 2B;

FIG. 3C is a photograph at 100× magnification of the plated steel coin shown in FIG. 2C;

FIG. 4A is a photograph at 50× magnification of a 15 micron, mono-ply Nickel plated steel coin, which was heated at a temperature of 850° C. after plating, after 12 hours of wear testing;

FIG. 4B is a photograph at 50× magnification of a 25 micron, mono-ply Nickel plated steel coin, which was heated at a temperature of 850° C. after plating, after 12 hours of wear testing;

FIG. 4C is a photograph at 50× magnification of a 25 micron, mono-ply Nickel plated steel coin, which was heated at a recrystallization temperature of 780° C. before being Nickel plated and then heated at a temperature of 450° C. to remove plating stresses, after 12 hours of wear testing;

FIG. 5A is a photograph at 100× magnification of the plated steel coin shown in FIG. 4A;

FIG. 5B is a photograph at 100× magnification of the plated steel coin shown in FIG. 4B;

FIG. 5C is a photograph at 100× magnification of the plated steel coin shown in FIG. 4C;

FIG. 6A is a photograph at 50× magnification of a 15 micron, mono-ply Nickel plated steel coin, which was heated at a temperature of 850° C. after plating, after 36 hours of wear testing;

FIG. 6B, is a photograph at 50× magnification of a 25 micron, mono-ply Nickel plated steel coin, which was heated at a temperature of 850° C. after plating, after 36 hours of wear testing;

FIG. 6C is a photograph at 50× magnification of a 25 micron, mono-ply Nickel plated steel coin, which was heated at a recrystallization temperature of 780° C. before being Nickel plated and then heated at a temperature of 450° C. to remove plating stresses, after 36 hours of wear testing;

FIG. 7A is a photograph at 100× magnification of the plated steel coin shown in FIG. 6A;

FIG. 7B is a photograph at 100× magnification of the plated steel coin shown in FIG. 6B;

FIG. 7C is a photograph at 100× magnification of the plated steel coin shown in FIG. 6C;

FIG. 8A is a photograph at 50× magnification of a 15 micron, mono-ply Nickel plated steel coin, which was heated at a temperature of 850° C. after plating, after 96 hours of wear testing with the Gesswein™ tumbler at 30 RPM.

FIG. 8B, is a photograph at 50× magnification of a 25 micron, mono-ply Nickel plated steel coin, which was heated at a temperature of 850° C. after plating, after 96 hours of wear testing with the Gesswein™ tumbler at 30 RPM

FIG. 8C is a photograph at 50× magnification of a 25 micron, mono-ply Nickel plated steel coin, which was heated at a recrystallization temperature of 780° C. before being Nickel plated and then heated at a temperature of 450° C. to remove plating stresses, after 96 hours of wear testing with the Gesswein™ tumbler at 30 RPM.

FIG. 9A is a photograph at 50× magnification of the plated steel coin shown in FIG. 8A at another location on the coin.

FIG. 9B is a photograph at 50× magnification of the plated steel blank coin in FIG. 8B at another location on the coin; and

FIG. 9C is a photograph at 50× magnification of the plated steel blank coin in FIG. 8C at another location on the coin.

### DETAILED DESCRIPTION

Generally, the present disclosure provides a method for plating coin blanks.

The method includes: heating metal or alloy blanks at a recrystallization temperature sufficient for the metal or alloy to undergo a recrystallization to soften the metal or alloy for minting; plating the softened metal or alloy blanks with one or more layers of metal or alloy; and heating the plated blanks at a temperature sufficient to reduce or remove plating stresses but below the recrystallization temperature of the outermost plating layer.

The metal or alloy blanks are heated to a recrystallization temperature sufficient for the metal or alloy to undergo a recrystallization to soften the metal or alloy. The metal or alloy may be, for example, steel, copper, aluminum, aluminum alloy, zinc alloy, brass, aluminum/bronze, commercial brasses or bronzes known in the art, or any other alloys used as blanks in minting. Specific alloys that may be used include, for example, 60Cu/40Zn alloys, 70Cu/30Zn alloys, 80Cu/20Zn alloys, Cu/Zn/Sn alloys, white bronze, and cupro-nickel alloys.

Some low carbon steels, for example, undergo a recrystallization around 750° C. Depending on the carbon content of the steel used in the steel blanks, the steel blanks may be heated, for example, at a recrystallization temperature of 725 to 950° C. to soften the steel for minting. Copper blanks may be heated, for example, at a recrystallization temperature between about 625° C. and about 675° C. Brass blanks may be heated, for example, at a recrystallization temperature between about 650° C. and about 700° C. Aluminum/bronze blanks may be heated, for example, at a recrystallization temperature between about 700° C. and about 750° C.

In particular methods, the steel blanks are heated at a recrystallization temperature of 800° C. to 850° C. The steel blanks should be softened sufficiently that the coining die does not require undue force to mint the coins. The higher the carbon content of the steel blanks (greater than 0.4 wt %), the higher the desired recrystallization temperature used to soften the steel. The resulting softened steel blanks may have, for example, a steel core hardness of about 27 to about 35 on the R 30T scale.

Heating the metal or alloy blanks may also remove, through combustion, organic compounds that are coating the metal or alloy. It is less critical to clean blanks using a solvent or aggressive chemical if the metal or alloy blanks are cleaned by being heated at an elevated temperature.

The metal or alloy blanks may be heated in a reducing atmosphere, for example if the metal or alloy blanks are steel blanks the reducing atmosphere helps to remove rust present on the steel blanks. A reducing atmosphere may be an atmosphere that includes, for example, cracked ammonia, a mixture of nitrogen and hydrogen ranging from greater than 0% to 100% hydrogen, an endothermic gas, or an exothermic gas.

An endothermic gas may be produced through the incomplete combustion of hydrogen, nitrogen and air in a controlled environment, as illustrated in the reaction below.

2CH₄+O₂→2CO+4H₂.

Since both the produced hydrogen and carbon monoxide are reducing agents, the gas by the reaction prevents metal or alloy from oxidizing. At an industrial scale, natural gas may be burned under reduced oxygen levels, in the presence of a catalyst, using external heating at about 1000° C. Since such a process requires a supply of energy, it is an endothermic process and the produced gas is termed an “endothermic gas”. When the metal is steel, the presence of CO may increase the carbon content of the steel and may make the steel harder.

An exothermic gas may be generated by burning natural gas with air, as illustrated in the reaction below:

CH₄+O₂→CO₂+2H₂.

Since such a process generates energy, it is an exothermic process and the produced gas is termed an “exothermic gas”.

Carbon dioxide and hydrogen are generated. Excess air may be used in order to increase the amount of nitrogen in the combustion chamber. The produced hydrogen and oxygen from the added air may react to form water vapour. When the metal is steel, the carbon dioxide and hydrogen may reduce the carbon content of the steel since carbon dioxide may react with carbon to form carbon monoxide, and the produced water vapour may react with carbon to form carbon monoxide and hydrogen.

Both endothermic and exothermic gases are considered as reducing environment and can be used to protect steel from rusting.

The softened metal or alloy blanks may be cleaned before they are plated, for example by being heated in a reducing atmosphere.

The metal or alloy blanks may be heated in a reducing atmosphere that includes hydrogen. Such an atmosphere may burn off soil and/or oil used during the production of the metal or alloy blanks. If the metal is steel, hydrogen may also prevent the steel from rusting due to trace oxygen introduced by infiltration of air into the furnace since hydrogen will react with the trace oxygen.

The softened metal or alloy blanks may be plated using a mono-ply, bi-ply or multi-ply process to plate the metal or alloy with a metal or alloy plating. The metal or alloy used in the plating may be, for example nickel and/or copper, and optionally zinc, tin, brass, or bronze. After plating, the blanks may be rinsed and dried before being annealed at an elevated temperature.

The plated metal or alloy blanks may be heated at a temperature sufficient to reduce plating stresses but below the recrystallization temperature of the outermost plating layer in a neutral or reducing atmosphere to reduce oxidation of plating chemical residues and/or to remove, through combustion, organic compounds that are coating the plated blanks. The reducing atmosphere may be the same as, or different from, the reducing atmosphere used in the recrystallization process.

The temperature used to reduce plating stresses in the plated blanks is determined based on the outermost layer of metal or alloy used to plate the metal or alloy blank. The temperature is selected such that it is high enough to affect the plating grain structure, thereby reducing plating stresses and/or hydrogen embrittlement, but not so high that the blank surface micro hardness is affected. The recrystallization temperature for a metal or alloy is known in the art. The temperature used to reduce plating stresses is selected such that it is below the recrystallization temperature of the outermost layer of metal or alloy plating.

A metal or alloy plating which has not been heated to reduce plating stresses and which does exhibit plating stresses and/or hydrogen embrittlement may have a distorted, mixed and/or twisted grain structure. A metal or alloy plating heated to the recrystallization temperature of the outermost layer of metal or alloy plating may exhibit a grain structure formed of large grains. A metal or alloy heated to the selected temperature may have a grain structure formed of small grains of uniform geometry.

The temperature used to reduce plating stresses may be selected, for example to be about 200° C. to 300° C. lower than the recrystallization temperature. The temperature used to reduce plating stresses may be, for example, from 425° C. to 500° C. for nickel, from 225° C. to 275° C. for copper, from 350° C. to 475° C. for brass, or from 375° C. to 500° C. for bronze.

Hydrogen may be generated during the plating process and entrapped in the plated layers of metal or alloy. Hydrogen entrapped in the plated blanks may result in hydrogen embrittled blanks. Heating the plated blanks at a temperature sufficient to reduce plating stresses but below the recrystallization temperature of the outermost plating layer also aids in the removal of entrapped hydrogen by heating the metal or alloy sufficiently to release the entrapped hydrogen gas, thereby reducing the possibility that the annealed blanks will experience hydrogen embrittlement.

The produced blanks may have a plating thickness which is less than 25 microns thick while having wear and tear characteristics which are the same as, or better than, plated blanks which are heated at a temperature of 800° C. to 900° C. For example, the produced blanks heated to reduce plating stresses at 400° C. to 500° C. may be plated with 10 to 12 microns of nickel while having wear and tear characteristics which are the same as, or better than, plated blanks having 25 microns of nickel heated at a temperature of 800° C. to 900° C.

The produced blanks heated to reduce plating stresses may have, for example, a surface micro hardness which is about 60% harder than plated blanks which are heated at a temperature of 800 to 900° C. The produced blanks heated to reduce plating stresses may have, for example, a nickel or copper superficial micro hardness of about 230 to about 250 on the Vickers Scale measured with a force of 10 g and a dwell time of 15 seconds for nickel plating. Such a hardness provides desirable wear resistance.

Steel blanks may be produced from a strip of hard steel, which is cut into blanks of desired geometric shape, deburred and rimmed to smooth the edge. Plating the steel blank with nickel and/or copper may include: heating steel blanks at a recrystallization temperature between 725° C. and 950° C. to produce softened steel blanks, where the recrystallization temperature is selected based on the type of steel being used; plating the softened blanks with one or more metal and/or one or more metal alloy, for example copper, nickel, zinc, brass or bronze. If the plating is done with an acid solution, such as with nickel sulphate or nickel sulfamate, the plating process is an acid plating process.

The recrystallization temperature may be determined based on the carbon content of the steel. Carbon content of steel may vary between 0.04 wt % and 0.08 wt %, with the greater carbon content resulting in a harder steel and a higher temperature needed to sufficiently soften the steel for minting. For example, steel having a carbon content of 0.08 wt % may be heated to a temperature of 900° C. or higher in order to soften the steel sufficiently for minting.

Plating the blank with a single layer of metal or alloy is known as a mono-ply plating process. Plating the blank with a two layers of metal or alloy, such as copper followed by nickel, is known as a bi-ply plating process. Plating the blank with a more than two layers of metal or alloy, such as nickel, copper, nickel or nickel, copper, brass, is known as a multi-ply plating process.

### Example 1

Three different sets of blanks were made and the hardness of each blank was measured on the Vickers scale with a force of 10 g and a dwell time of 15 seconds.

Sample Set A is a set of 15 micron, mono-ply Nickel plated steel blanks, which were heated at a temperature of 850° C. after plating.

Sample Set B is a set of 25 micron, mono-ply Nickel plated steel blanks, which were heated at a temperature of 850° C. after plating.

Sample Set C is a set of 25 micron, mono-ply Nickel plated steel blanks, where the steel blanks were heated at a recrystallization temperature of 780° C. before being Nickel plated and then heated at a temperature of 450° C. to remove plating stresses.

Sample Set D is a set of 15 micron, mono-ply Nickel plated steel blanks, where the steel blanks were heated at a recrystallization temperature of 780° C. before being Nickel plated and then heated at a temperature of 450° C. to remove plating stresses.

The measured superficial hardness values of the samples are shown below in Table 1.

TABLE 1

| Sample # | Sample Set A | Sample Set B | Sample Set C | Sample Set D |
|---|---|---|---|---|
| 1 | 178 | 240 | 251 | 229 |
| 2 | 205 | 204 | 223 | 230 |
| 3 | 214 | 196 | 280 | 231 |
| 4 | 185 | 206 | 262 | 232 |
| 5 | 191 | 216 | 212 | 239 |
| 6 | 220 | 186 | 221 | 243 |
| 7 | 132 | 184 | 257 | 237 |
| 8 | 213 | 203 | 220 | 248 |
| 9 | 202 | 206 | 224 | 235 |
| 10 | 202 | 211 | 232 | 264 |
| 11 | 208 | 209 | 232 | 235 |
| 12 | 216 | 204 | 269 | 241 |
| 13 | 188 | 190 | 259 | 260 |
| 14 | 190 | 212 | 276 | 231 |
| 15 | 214 | 227 | 256 | 249 |
| 16 | 182 | 189 | 231 | 258 |
| 17 | 196 | 237 | 255 | 232 |
| 18 | 189 | 213 | 263 | 241 |
| 19 | 212 | 215 | 229 | 232 |
| 20 | 199 | 203 | 247 | 240 |
| Average | 197 | 208 | 243 | 240 |
| Std Dev | 19.7 | 15.2 | 20.4 | 10.4 |

As illustrated in Table 1, the 66% increase in the thickness of plated nickel in Sample Set A vs. Sample Set B (i.e. an increase from 15 microns to 25 microns) resulted in an increase of about 5% in micro hardness (208 vs. 197). In contrast, blanks plated according to one aspect of the present application (Sample Set C) resulted in an increase in micro hardness of about 19% (243 vs. 208) for blanks plated with 25 microns of nickel. Further, blanks plated with 15 microns of nickel according to an aspect of the present application (Sample Set D) resulted in plated blanks having a similar micro-hardness to the blanks plated with 25 microns of nickel. Increasing the thickness of the plating does not necessarily increase the micro-hardness of the plating.

### Example 2

Wear can be numerically quantified by the amount of material loss over time. Resistance to wear can be qualitatively assessed by determining the quality of the coin surface over time. Less denting, as seen on the coin surface after the coin is subjected to physical abuse, is preferred.

The four sets of blanks (Sample Sets A, B, C, D) above were struck into coins and then these coins were put into the wear test.

Sample Coin Set A is a set of 15 micron, mono-ply Nickel plated steel coins, where the steel blanks were heated at a temperature of 850° C. after plating.

Sample Coin Set B is a set of 25 micron, mono-ply Nickel plated steel coins, where the steel blanks were heated at a temperature of 850° C. after plating.

Sample Coin Set C is a set of 25 micron, mono-ply Nickel plated steel coins, where the steel blanks were heated at a recrystallization temperature of 780° C. before being Nickel plated and then heated at a temperature of 450° C. to remove plating stresses.

Sample Coin Set D is a set of 15 micron, mono-ply Nickel plated steel coins, where the steel blanks were heated at a recrystallization temperature of 780° C. before being Nickel plated and then heated at a temperature of 450° C. to remove plating stresses.

To assess wear and wear resistance, 30 coins (10 each from Sample Coin Sets A, B and C) were loaded in a 6″ diameter tumbler which was rotated at 8 RPM for up to 40 hours. One coin of each sample coin set was removed every four hours and replaced with an unlabeled coin of the same type to maintain a total of 30 coins, for a total of 40 hours of wear testing. The plated coins were weighed before and after wear testing to determine mass loss.

The mass loss for individual plated coins is shown below in Table 2.

TABLE 2

| Time | Sample Coin | Sample Coin | Sample Coin |
|---|---|---|---|
| Removed | Set A | Set B | Set C |
| (hours) | (loss in grams) | (loss in grams) | (loss in grams) |
| 4 | 0.00 | 0.00 | 0.00 |
| 8 | 0.01 | 0.00 | 0.00 |
| 12 | 0.01 | 0.01 | 0.01 |
| 16 | 0.00 | 0.01 | 0.00 |
| 20 | 0.00 | 0.00 | 0.00 |
| 24 | 0.00 | 0.00 | 0.01 |
| 28 | 0.00 | 0.01 | 0.00 |
| 32 | 0.00 | 0.00 | 0.01 |
| 36 | 0.01 | 0.01 | 0.01 |
| 40 | 0.00 | 0.00 | 0.00 |

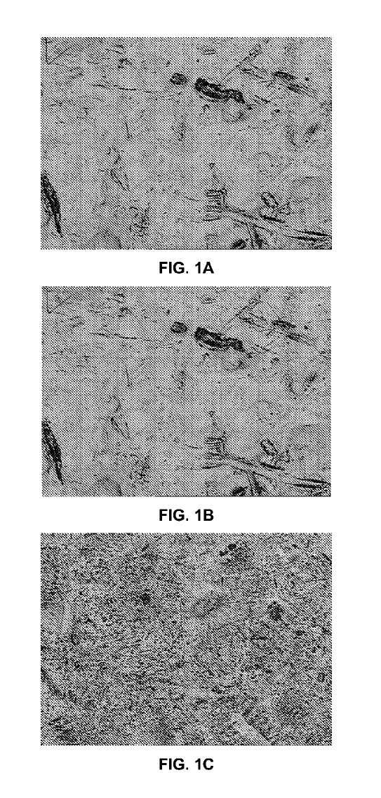

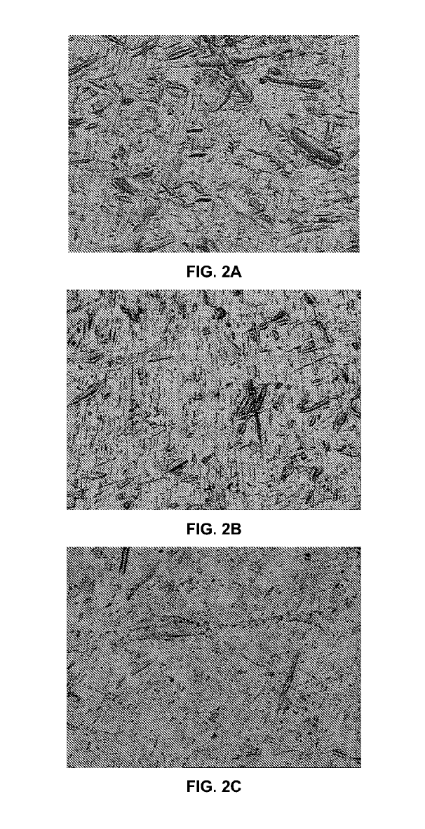

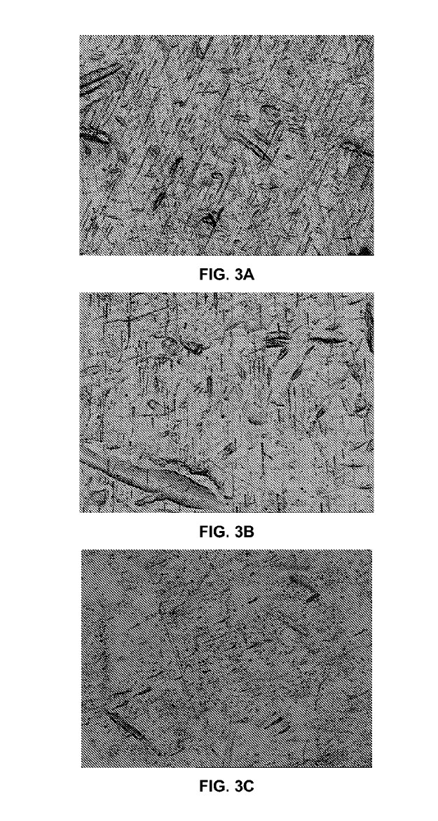

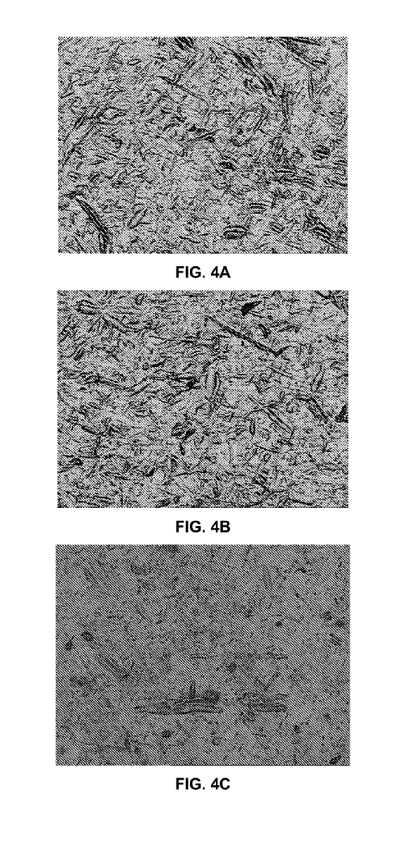

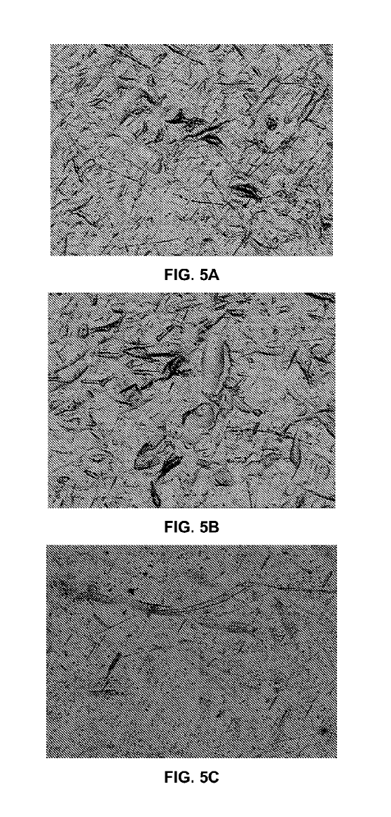

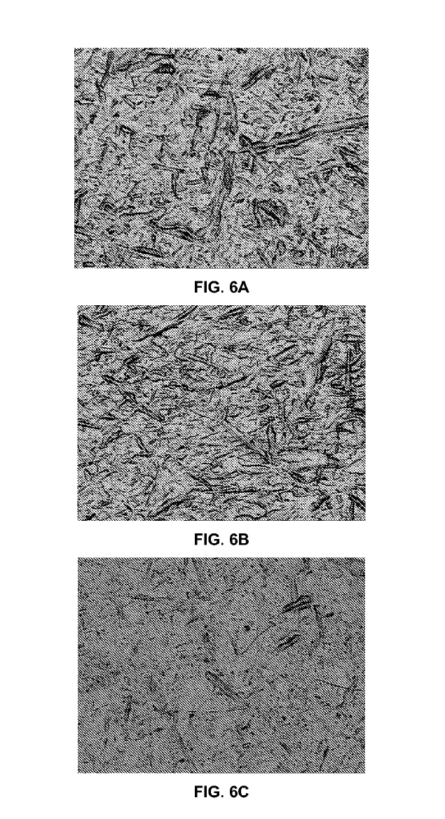

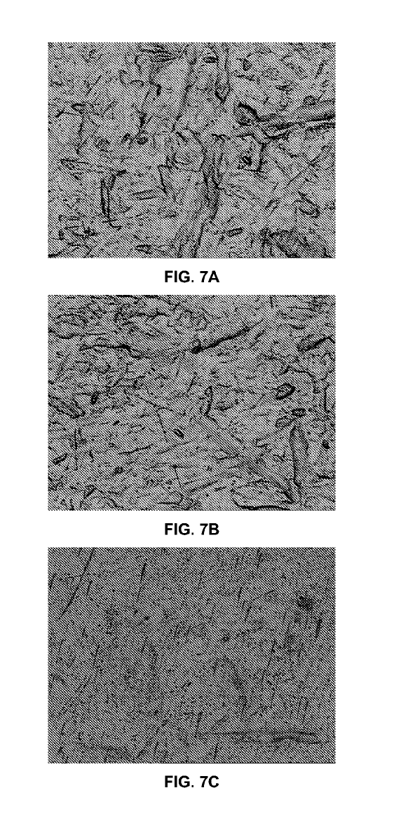

Photographs taken at 50× and at 100× magnification after 0, 4, 12, and 36 hours of wear test are illustrated in FIGS. 1A to 7C. Although the weight loss of the 3 Sample Coin Sets A, B and C is negligible under these wear test condition, as illustrated in these Figures, coins of Sample Coin Set C, plated according to one aspect of the present application, show less denting and surface damage than the coins of Sample Coin Sets A or B.

### Example 3

Another set of wear tests was conducted using 40 plated coins from each of Sample Sets A, B, C and D. The plated blanks were loaded in a dry Gesswein™ tumbler which was rotated at 30 RPM for up to 96 hours. The inner wall of the tumbler was lined with cotton fabric to improve the tumbling action of the coins. Ten coins were removed every 24 hours and replaced with new unlabeled coins of the same type to maintain a total of 40 coins. The removed coins were weighed before and after wear testing to determine mass loss. The percent mass loss for the sample sets is shown below in Table 3.

TABLE 3

| | Sample | Sample | Sample | Sample |
|---|---|---|---|---|
| | Coin | Coin | Coin | Coin |
| Time | Set A | Set B | Set C | Set D |
| Removed | (% mass | (% mass | (% mass | (% mass |
| (hours) | loss) | loss) | loss) | loss) |
| 24 | 0% | 0% | 0% | 0% |
| 48 | 0% | 0% | 0% | 0% |
| 72 | 0% | 0% | 0% | 0% |
| 96 | 0.50% | 0.24% | 0.07% | 0.07% |

As illustrated in Table 3, after 96 hours of wear testing under the above conditions, the blanks of Sample Coin Sets C and D show less material loss than the coins of Sample Coin Sets A or B, indicating that the coins of Sample Coin Sets C and D are more wear resistant than the blanks of the other sample sets.

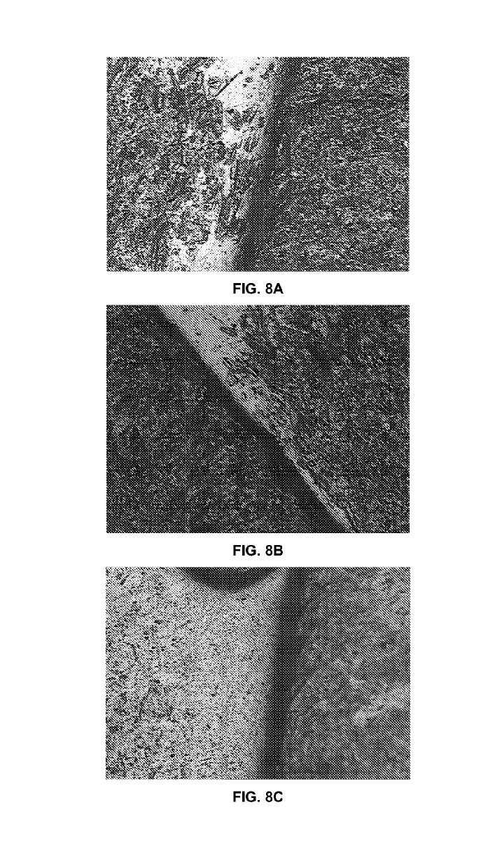

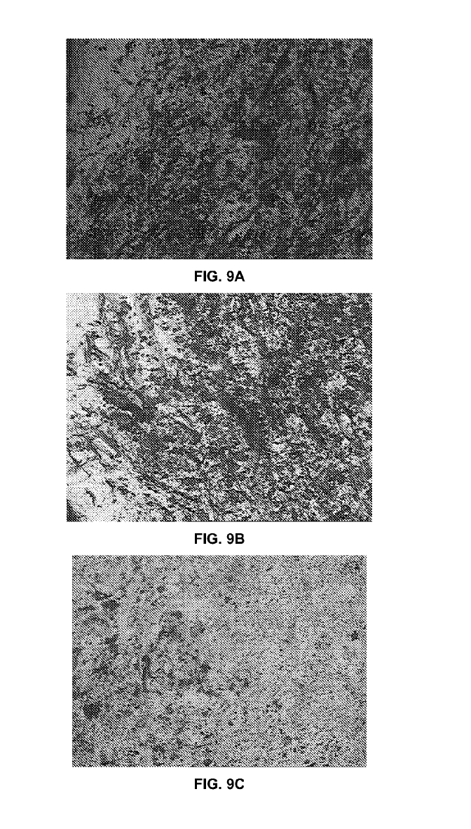

Photographs taken at 50× and at 100× magnification after 96 hours of wear test of Sample Coin Sets A, B and C are illustrated in FIGS. 8A to 9C. As illustrated in these Figures, coins of Sample Coin Set C, plated according to one aspect of the present application, show less denting and surface damage than the coins of Sample Coin Sets A or B.

### Example 4

Another set of wear tests were conducted on different types of plated blanks prepared according to the present description, as well as a control set of blanks, where all the blanks were struck into coins before wear testing. Although the coins made for this wear test were made using a batch process, the coins could alternatively be made using a continuous process, for example using a belt heater having a plurality of zones of varying temperatures.

The control sample (Sample Coin Set E) was a set of 20 coins made from steel blanks which were: cleaned; plated with 25 microns of nickel; burnished; annealed by heating the plated blanks in an oven under a reducing environment (8% H₂ and 92% N₂) from room temperature to 750° C. over the course of about 45 minutes, and at 750° C. for about 1 hour; cooled to about 550° C. in the oven under the reducing environment over the course of 2-3 hours; cooled to room temperature out of the oven; and then struck into coins.

One sample (Sample Coin Set F) was a set of 20 coins prepared according to the present description. The steel blanks were: cleaned; annealed to soften the steel by heating the plated blanks in an oven under a reducing environment (8% H₂ and 92% N₂) from room temperature to 750° C. over the course of about 45 minutes, and at 750° C. for about 1 hour; cooled to about 550° C. in the oven over the course of 2-3 hours; cooled to room temperature out of the oven for about 30 minutes; plated with 25 microns of nickel; annealed to remove plating stresses by heating the plated blanks in an oven under a reducing environment (8% H₂ and 92% N₂) from room temperature to 450° C. over the course of about 30 minutes, and at 450° C. for about 1 hour; cooled to room temperature in the oven under the reducing environment over the course of 2 hours or overnight; burnished; and struck into coins.

Another sample (Sample Coin Set G) was a set of 20 coins prepared according to the present description. The steel blanks were: cleaned; annealed to soften the steel by heating the plated blanks in an oven under a reducing environment (8% H₂ and 92% N₂) from room temperature to 750° C. over the course of about 45 minutes, and at 750° C. for about 1 hour; cooled to about 550° C. in the oven over the course of 2-3 hours; cooled to room temperature out of the oven for about 30 minutes; plated with 5 microns of nickel, 13 microns of copper and 7 microns of nickel; annealed to remove plating stresses by heating the plated blanks in an oven under a reducing environment (8% H₂ and 92% N₂) from room temperature to 450° C. over the course of about 30 minutes, and at 450° C. for about 1 hour; cooled to room temperature in the oven under the reducing environment over the course of 2 hours or overnight; burnished; and struck into coins.

To assess wear of the three coin sets, 60 coins (20 each from Sample Coin Sets E, F and G) were loaded in a 6″ diameter tumbler which was rotated at 8 RPM for up to 80 hours. The coins of each coin set were weighed as a group and, after tumbling for a period of time, were cleaned of metal dust using compressed air and a cloth. The cleaned coins were weighed as a group. In order to determine mass loss, the mass of the coins was compared to the mass of the coins before wear testing. The coins were replaced in the tumbler and wear testing was continued for a total of 80 hours. The results, as average loss in mg per coin, are shown in Table 4.

TABLE 4

| Time Removed | Sample Coin Set E | Sample Coin Set F | Sample Coin Set G |
|---|---|---|---|
| (hours) | (weight loss, mg) | (weight loss, mg) | (weight loss, mg) |
| 0 | 0 | 0 | 0 |
| 16 | 140 | 40 | 100 |
| 82 | 720 | 140 | 380 |

As illustrated in Table 4, coins made from blanks which were plated with a plating layer, and then heated to reduce plating stresses, have a harder outer coating (that is, the outer plating layer) than coins made from blanks which were plated and annealed at a temperature above the recrystallization temperature of the plating layer. The harder outer coating results in a reduction in mass loss for Coin Sets F and G, in comparison to control Coin Set E.

In the preceding description, for purposes of explanation, numerous details are set forth in order to provide a thorough understanding of the embodiments. However, it will be apparent to one skilled in the art that these specific details are not required. The above-described embodiments are intended to be examples only. Alterations, modifications and variations can be effected to the particular embodiments by those of skill in the art without departing from the scope, which is defined solely by the claims appended hereto.

1. A method for plating metal or alloy blanks that are steel, copper, brass or bronze, the method comprising:
heating the metal or alloy blanks at or above a recrystallization temperature sufficient to soften the metal or alloy for minting;
plating the softened blanks with one or more layers of metal or alloy, the outermost plating layer comprising nickel; and
heating the plated blanks at a temperature above 225° C. and below 500° C. to reduce plating stresses the outermost plating layer.

2. The method according to claim 1, wherein the metal or alloy blanks are steel.

3. The method according to claim 1, wherein the metal or alloy blanks are 60Cu/40Zn alloys, 70Cu/30Zn alloys, 80Cu/20Zn alloys, Cu/Zn/Sn alloys, white bronze, or cupro-nickel blanks.

4. The method according to claim 2, wherein the blanks are steel blanks and are heated at a recrystallization temperature between about 725° C. and about 950° C.

5. The method according to claim 2, wherein the blanks are copper blanks and are heated at a recrystallization temperature between about 625° C. and about 675° C.

6. The method according to claim 2, wherein the blanks are brass blanks and are heated at a recrystallization temperature between about 650° C. and about 700° C.

7. The method according to claim 2, wherein the blanks are aluminum/bronze blanks and are heated at a recrystallization temperature between about 700° C. and about 750° C.

8. The method according to claim 2, wherein the blanks are steel blanks and are heated for about 1 hour.

9. The method according to claim 1, wherein the plated blanks are heated to reduce plating stresses at a temperature above 400° C. and below 500° C.

10. The method according to claim 1, wherein the plated blanks are heated to reduce plating stresses for about 1 hour.

11. The method according to claim 1, wherein the plated blanks are heated from room temperature to the temperature sufficient to reduce plating stresses and cooled back down to room temperature over the course of about 1.5 to about 3 hours.

12. The method according to claim 1, wherein the metal blanks are heated in a reducing atmosphere.

13. The method according to claim 12, wherein the reducing atmosphere comprises: cracked ammonia, a mixture of nitrogen and hydrogen ranging from greater than 0% to 100% hydrogen, an exothermic gas or an endothermic gas.

14. The method according to claim 1, wherein the plated blanks are heated to reduce plating stresses in a neutral or a reducing atmosphere.

15. A plated steel blank comprising:
a steel core having a bulk hardness of between about 27 and 53 on the R30T scale; and
at least one plating layer, of which one of the at least one plating layer is an outermost plating layer, the outermost plating layer comprising nickel and having a micro hardness of about 245 to about 280 on the Vickers Scale measured with a force of 10 g and a dwell time of 15 seconds.

16. The plated steel blank according to claim 15, wherein the total thickness of the plating layer or layers is about 12 to 25 microns.

17. The method according to claim 1, wherein the outermost plating layer is a nickel plating layer.

18. The plated steel blank according to claim 15, wherein the outermost plating layer is a nickel plating layer.

19. The method according to claim 1, wherein the plated blanks are heated to reduce plating stresses at a temperature of about 450° C.
